(19) United States
(12) Patent Application Publication
(10) Pub. No.: US 2003/0162570 A1
(43) Pub. Date: Aug. 28, 2003

(54) Mobile radio device

(76) Inventors: Michitaka Suzuki, Shizuoka (JP); Hirotsugu Matsuura, Kanagawa (JP)

Correspondence Address: PEARNE & GORDON LLP, 526 SUPERIOR AVENUE EAST, SUITE 1200, CLEVELAND, OH, 44114-1484, US

(21) Appl. No.: 10/312,958

(22) PCT Filed: Apr. 9, 2002
(86) PCT No.: PCT/JP02/03546

(30) Foreign Application Priority Data
Apr. 27, 2001 (JP) 2001-132234

(51) Int. Cl. H04B 1/38

(52) U.S. Cl. 455/566; 455/575

(57) ABSTRACT

An object of the present invention is to reduce current consumption of the overall device containing a display portion in the communication mode.

In the present invention, a control portion (18) of a mobile radio device outputs a control signal to an LCD driving portion (19) to drive an LCD (15) and to execute display control. When the device is in a communication mode by a radio communication portion (17), a mode display is executed in a background that has a color of a turn-OFF mode by using a color of a turn-ON mode on the display screen of the LCD (15), for example, the modes display such as “talking”, or the like is executed in the background in black color by characters in white color. Also, a partial display is executed such that a display only in an area in which the mode display is executed is turned ON and the display in other areas is turned OFF. Accordingly, the current consumption of the LCD (15) can be reduced.

### TECHNICAL FIELD

The present invention relates to a mobile radio device having a radio communicating means such as a mobile phone.

### BACKGROUND ART

In the mobile radio device having the radio communicating means such as the mobile phone, a display portion for displaying use conditions such as an operation mode, an electric field strength, a battery remaining capacity, a communication destination, etc., and communication contents so as to permit the user to know them is provided. As this display portion, a liquid crystal display device constructed by liquid crystal display elements (referred to as “LCD” hereinafter) is generally employed.

A display screen of LCD, which becomes white when respective pixels are turned ON and becomes black when respective pixels are turned OFF, is common. For example, the display screen of the RGB additive mixture of color stimuli type, which is widely employed as the color LCD, become white when all RGBs are turned ON and becomes black when all RGBs are not turned ON. For this reason, current consumption tends to increase as turned-ON portions such as the white areas are increased in the display screen.

In the mobile radio device, “talking” and phone number, name, etc. of the person on the other end, for example, are displayed on the display screen during talking. At this time, if black characters are displayed in the white background on the display screen, the background that occupies most part of the display screen is turned ON as white and only character portions that occupies a small area are not turned ON as black, so that the current consumption is increased. In such mobile radio device, various power saving functions are provided to lengthen the life of the battery. The current consumption is increased with the tendency of the increase in size of the display portion, and thus further power saving in the display portion is desired.

As described above, further power saving is desired with the increase in screen size of the display portion by the LCD in the mobile radio device. In this case, in the event that the characters, etc. are to be displayed in the display screen, the current consumption is increased in some cases when the background that occupies most part of the display screen is brought into the turn-ON state and only the character portions that occupies the small area is brought into the turn-OFF state such that the black characters are displayed in the white background on the display screen, or the like. For example, the displays such as “talking”, etc. are indicated when the device is in the talking mode. In this case, in the actual talking mode, the user puts the device main body to the ear in many cases and thus the user is brought into such a state that he or she cannot look at the characters, etc. that are being displayed on the display portion, nevertheless sometimes much power is consumed by the LCD display other than the radio portion.

The present invention has been made in view of the above circumstances, and it is an object of the present invention to provide a mobile radio device capable of reducing a current consumption of the overall device containing a display portion in the communication state.

### DISCLOSURE OF THE INVENTION

A mobile radio device of the present invention includes a radio communication portion for executing communication via radio; a display portion for displaying an operation mode of the device; and a control portion for causing the display portion to execute a mode display in a background that has a color at a time of a turn-OFF mode by using a color at a time of a turn-ON mode when the device is in a communication mode by the radio communication portion.

Also, preferably the control portion causes the display portion to execute a mode display in the background in black color indicating the time of the turn-OFF mode by characters in white color indicating the time of the turn-ON mode when the device is in the communication mode.

Also, preferably the control portion causes the display portion to execute such a partial display that a display only in an area in which the mode display is executed is turned ON and the display in other areas is turned OFF when the device is in the communication mode.

Also, preferably the mobile radio device further comprises a sensing means for sensing a situation that the device comes close to a user's head, and the control portion causes the display portion to turn OFF a display in all or a part of display area in the display portion when approach of the head is sensed by the sensing means.

According to the above configuration, when the device is in a communication mode, a mode display is executed in a background that has a color of a turn-OFF mode by using a color of a turn-ON mode on the display portion, for example, the modes display is executed in the background in black color by characters in white color. Also, a partial display is executed such that a display only in an area in which the mode display is executed is turned ON and the display in other areas is turned OFF. Accordingly, the current consumption in the display portion can be reduced and thus power saving of the overall device can be achieved. Also, when it is sensed that the device comes close to the user's head, the device is in the talking mode and thus the user cannot look at the display portion. Therefore, since it is regarded that the mode display is not needed and thus a display in all or a part of display area in the display portion is turned OFF, the current consumption in the display portion can be reduced and the power saving of the overall device can be attained.

### BRIEF DESCRIPTION OF THE DRAWINGS

FIG. 1 is an explanatory view showing an external appearance of a mobile radio device according to a first embodiment of the present invention.

FIG. 2 is a block diagram showing a functional configuration of the mobile radio device according to the first embodiment.

FIG. 3 is an explanatory view showing an operation of a first example of LCD display in the talking mode in the present embodiment.

FIG. 4 is an explanatory view showing an operation of a second example of LCD display in the talking mode in the present embodiment.

FIG. 5 is an explanatory view showing an external appearance of a mobile radio device according to a second embodiment of the present invention.

FIG. 6 is a block diagram showing a functional configuration of the mobile radio device according to the second embodiment.

In this case, in above figures, symbols 10, 20 are a mobile radio device, 11 is an device main body, 12 is an antenna, 13 is a receiver portion, 14 is a transmitter portion, 15 is a liquid crystal display device (LCD), 16 is an operation portion, 17 is a radio communication portion, 18, 24 are a control portion, 19 is an LCD driver portion, and 22 is a sensor.

### BEST MODES FOR CARRYING OUT THE INVENTION

Embodiments of the present invention will be explained with reference to the drawings hereinafter.

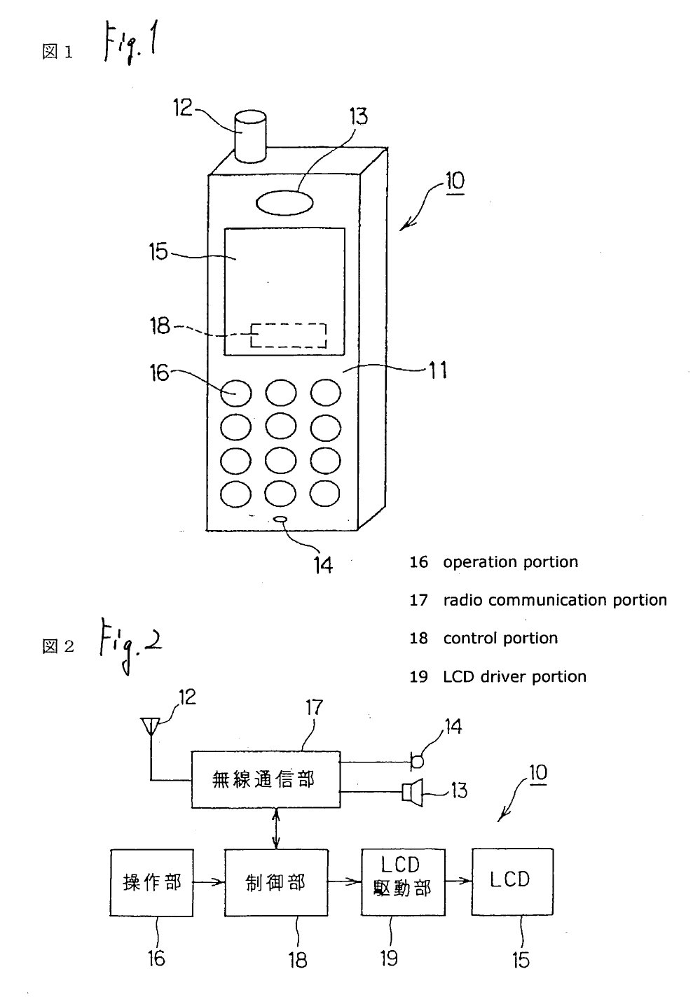

FIG. 1 is an explanatory view showing an external appearance of a mobile radio device according to a first embodiment of the present invention, and FIG. 2 is a block diagram showing a functional configuration of the mobile radio device according to the first embodiment. In the present embodiment, explanation will be made while taking the cellular phone, which is employed as the sound communication in the mobile communication system, etc., as an example of the mobile radio device. This cellular phone can be applied to the cellular phone system such as PDC, IS-95, IMT2000 (W-CDMA, etc.) system, etc., the mobile terminal such as PHS (trade mark) system, etc.

A mobile radio device 10 is constructed by providing an antenna 12 for radio communication, a receiver portion 13 made of a loudspeaker or the like, a transmitter portion 14 made of a microphone or the like, a liquid crystal display device (LCD) 15 including the display portion, an operation portion 16 consisting of a plurality of operation keys to an device main body 11. In the inside of the device, a radio communication portion 17 including an RF portion and a base band portion, etc., to execute the radio communication such as the sound communication, a control portion 18 for executing various controls of the mobile radio device 10, and an LCD driver portion 19 for driving the LCD 15 are provided. The control portion 18 is connected to the radio communication portion 17, the operation portion 16, and the LCD driver portion 19, and executes operation control and screen display control in the radio communication.

In executing the sound communication by using the mobile radio device 10, when the phone number of the destination is input by pushing the operation keys on operation portion 16 to issue the originating indication after the location registration of the base station in the available area is completed by turning ON the power supply of the device, a call outgoing operation is carried out by the control portion 18 and the radio communication portion 17. When the line is established after the call comes into the destination, the communication can be established by transmitting and receiving the speech using the receiver portion 13 and the transmitter portion 14. At this time, a sound signal being input from the transmitter portion 14 is subjected to various signal processes such as coding, modulation, amplification, etc. in the radio communication portion 17 to form a transmitted signal, and then transmitted from an antenna 12. Also, a received signal received via the antenna 12 is subjected to various signal processes such as demodulation, decoding, amplification, etc. in the radio communication portion 17 to form the sound signal, and then output from the receiver portion 13.

Also, in operation of the mobile radio device 10, the control signal is output from the control portion 18 to the LCD driver portion 19 to drive/control the LCD 15 and to execute various mode displays on the display screen of the LCD 15. For example, the phone number of the destination, the name, operation modes such as the transmitting mode, the receiving mode, the talking mode, etc., the talking time, the charge for a phone call, etc. are displayed.

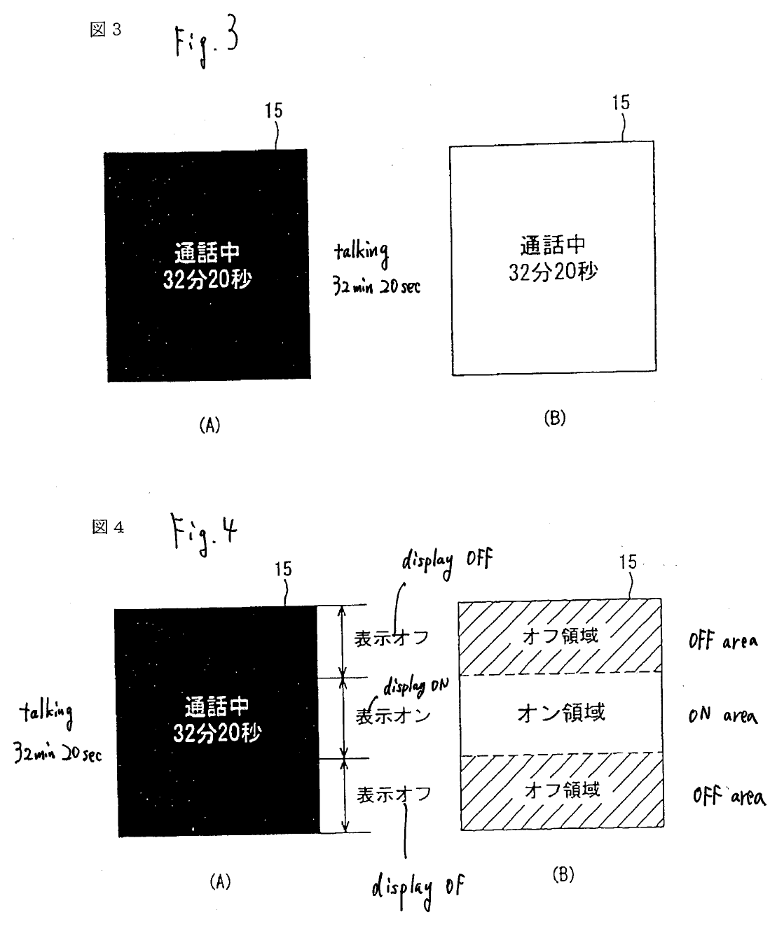

FIG. 3 is an explanatory view showing an operation of a first example of LCD display in the talking mode in the present embodiment. In the present embodiment, when particularly the mobile radio device 10 is in the talking mode, the state that the device is in the talking mode and the talking time such as “talking” “32 min 20 sec” are displayed by the white characters in the black background on the LCD 15, as shown in FIG. 3(A), under control of the control portion 18 and the LCD driver portion 19. In this case, this operation mode display may be displayed by using not only the character and the numeral but only the symbol, the image, etc.

In the conventional mobile radio device, as shown in FIG. 3 (B), for example, the mode display was executed by displaying the black characters in the white background. In contrast, in the present embodiment, as shown in FIG. 3(A), the mode display was executed by displaying the white characters in the black background. Thus, since the background portion that occupies most part of the area of the display screen is displayed in black color as the turn-OFF state color and the character portions that occupies the small area is displayed in white color as the turn-ON state color, the current consumption in the LCD 15 can be reduced. Therefore, in the operation mode such as at least the talking mode, etc., which has a degree of little importance of the display in the mobile radio device 10, the current consumption of the LCD 15 can be reduced without deterioration of the visibility. As a result, the current consumption of the overall device can be reduced.

FIG. 4 is an explanatory view showing an operation of a second example of LCD display in the talking mode in the present embodiment. In the second example of the present embodiment, in addition to the operation in the first example such that the mode display is executed by the white characters in the black background in the talking mode, partial display in which the LCD display is partially turned ON (called also as the “partial display” hereinafter) is executed.

In the case of the partial display, a duty ratio of the driving current to drive the LCD 15 is changed by the control portion 18 and the LCD driver portion 19 to turn ON the display only in a part of the display screen of the LCD 15 partially. As shown in FIG. 4 (A), the display in the area in which “talking” “32 min 20 sec” are displayed, i.e., only two rows that display these talking modes, is turned ON, and the display in remaining area (rows) is turned OFF. Therefore, as shown in FIG. 4 (B), only the portion of the LCD 15 that takes the charge of the mode display becomes the ON area and other areas become the OFF area. Therefore, the current consumption in the LCD 15 can be reduced further more, and also the current consumption of the LCD 15 can be reduced not to deteriorate the visibility. As a result, the current consumption of the overall device can be reduced much more.

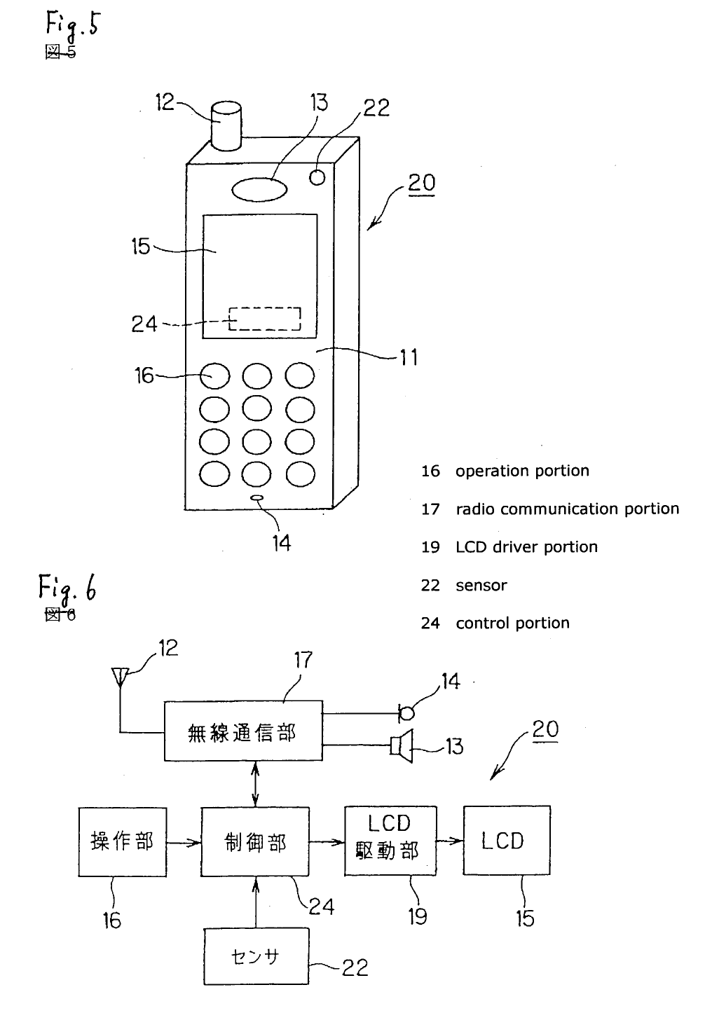

FIG. 5 is an explanatory view showing an external appearance of a mobile radio device according to a second embodiment of the present invention, and FIG. 6 is a block diagram showing a functional configuration of the mobile radio device according to the second embodiment.

The mobile radio device 20 of the second embodiment is a variation of the above-mentioned first embodiment, and is constructed such that a sensor 22 is provided as a sensing means for sensing the approach of the user's head and the display ON/OFF of the LCD 15 is executed by a control portion 24 based on an output of the sensor 22. Other portions are constructed similarly to the first embodiment, and thus their explanations will be omitted herein by affixing the same symbols to the same elements.

The sensor 22 includes a range sensor using the infrared ray, for example, and sends out a sensed output to the control portion 24 when such sensor senses the situation that the user's head comes close within a predetermined range. When the user brings the mobile radio device 20 close to the ear during the talking mode, the approach of the head is sensed by the sensor 22 and then the sensed output becomes active. The control portion 24 receives this sensed output, and then outputs the control signal to the LCD driver portion 19 to turn OFF the display in all or a part of the display screen of the LCD 15.

In the situation that the user brings the receiver portion 13 of the mobile radio device 20 close to the ear during the talking mode, the user cannot look at the display screen of the LCD 15 and therefore the talking mode display is not needed. For this reason, it is sensed by sensing the approach of the user's head that the device is in the talking mode, and then the display of the LCD 15 is turned OFF in the talking mode in which the user cannot look at the mode display. Thus, the current consumption in the LCD 15 can be reduced. Therefore, in the operation mode such as at least the talking mode, etc., which has a degree of little importance of the display in the mobile radio device 20, the current consumption of the LCD 15 can be reduced furthermore without deterioration of the visibility. As a result, the current consumption of the overall device can be reduced much more.

The present invention is explained in detail with reference to the particular embodiments. But it is apparent for the person skilled in the art that various variations and modifications can be applied without the departing from the spirit and the scope of the present invention.

The present application is based on Japanese patent application (Patent Application No. 2001-132234) filed on Apr. 27, 2001, and its contents are incorporated herein as the reference.

### INDUSTRIAL APPLICABILITY

As described above, according to the present invention, there is such an advantage that the mobile radio device that can reduce the current consumption of the overall device containing the display portion in the communication mode can be provided.

1. A mobile radio device comprising:
a radio communication portion for executing communication via radio;
a display portion for displaying an operation mode of the device; and
a control portion for allowing the display portion to execute a mode display by using a color at a time of a turn-ON mode in a background that has a color at a time of a turn-OFF mode, when the device is in a communication mode by the radio communication portion.

2. The mobile radio device according to claim 1, wherein the control portion allows the display portion to execute a mode display by characters in white color indicating the time of the turn-ON mode in the background in black color indicating the time of the turn-OFF mode, when the device is in the communication mode.

3. The mobile radio device according to claim 1, wherein the control portion allows the display portion to execute such a partial display that a display only in an area where the mode display is executed is turned ON, and the display in other areas is turned OFF when the device is in the communication mode.

4. The mobile radio device according to claim 1, further comprising a sensing means for sensing a situation that the device comes close to a user's head,
wherein the control portion allows the display portion to turn OFF a display in all or a part of display area in the display portion when approach of the head is sensed by the sensing means.
